(19) United States
(12) Patent Application Publication
(10) Pub. No.: US 2010/0328924 A1
(43) Pub. Date: Dec. 30, 2010

(54) LIGHTED UMBRELLA

(75) Inventor: Giovanni Nissen, Prato (IT)

Correspondence Address: Pearne & Gordon LLP, 1801 East 9th Street, Suite 1200, Cleveland, OH, 44114-3108, US

(73) Assignee: 3 G S.R.L., I-50019 SESTO FIORENTINO (IT)

(21) Appl. No.: 12/811,616

(22) PCT Filed: Feb. 8, 2008
(86) PCT No.: PCT/IB2008/000427

§ 371 Date: Jul. 2, 2010

(30) Foreign Application Priority Data
Jun. 13, 2007 (IT) FI2007A000132

(51) Int. Cl. F21V 9/16; A45B 3/02

(52) U.S. Cl. 362/84; 362/102

(57) ABSTRACT

Lighted umbrella (1) comprising a handle (2), a rod (3) fixed on said handle (2), a structure (9) for bearing a sheltering cover (5), said structure (9) being fixed to said rod (3), a ferrule (4) disposed on said rod (3) for fixing the waterproof sheltering cover (5), said rod (3) comprising at least a first (11) and second (12) hoses of transparent material which are separated by a hollow space, and said handle (2) comprising an electric circuit (14) connected to at least one LED (10) to make said rod (3) luminous.

### TECHNICAL FIELD OF THE INVENTION

The object of the present invention is a lighted umbrella.

Umbrellas usually comprise a rod of opaque material to which a handle and a waterproof sheltering cover are fixed, on the lower and upper end, respectively.

The sheltering cover is kept in position by a structure comprising rigid elements hinged to each other.

The shelter-cover bearing structure can be moved onto the rod by a cursor so as to shift the same cover from a position almost parallel to the rod (closed position) to a position in which it takes up the shape of a dome whose vertex is the axis of the rod (open position).

### BACKGROUND ART

Also known are type of umbrellas which are illuminated by different lightening devices.

A first known type of lighted umbrella provides for using one or more incandescence lamps disposed either within the handle or directly within the rod.

In this type of known umbrellas, the rod may be of transparent material so as to allow scattering light to be emitted throughout the same rod; alternatively, the rod may be opaque and having only the upper end (protruding from the sheltering cover) made of transparent material in order to obtain a “pointer” effect of the umbrella's tip.

The above described umbrellas, however, exhibit some drawbacks.

A first drawback lies in the fact that the known lighted umbrellas make use of lightening devices having a high energy consumption and, for this reason, can be used only for very short periods of time.

A second drawback is given by the fact that among the types of known umbrellas in which the rod is of transparent material, the latter is usually plexiglas or glass or, anyway, not having elevated shock or bending-resistance. This poor strength may seriously endanger the user's safety.

### DISCLOSURE OF THE INVENTION

The object of the present invention is to overcome the above drawbacks by providing a lighted umbrella which allows the user to be visible even under poor visibility conditions, said umbrella being also stress-resistant and safe in use.

These and further objects that will appear evident by the following detailed description, are achieved according to the present invention by providing a lighted umbrella having the structural and functional characteristics indicated in the appended independent claims, further embodiments of the invention being set forth in the corresponding dependent claims.

The invention is explained herebelow in greater details with reference to the accompanying drawings, which show an exemplary and non-limiting embodiment thereof. In the drawings:

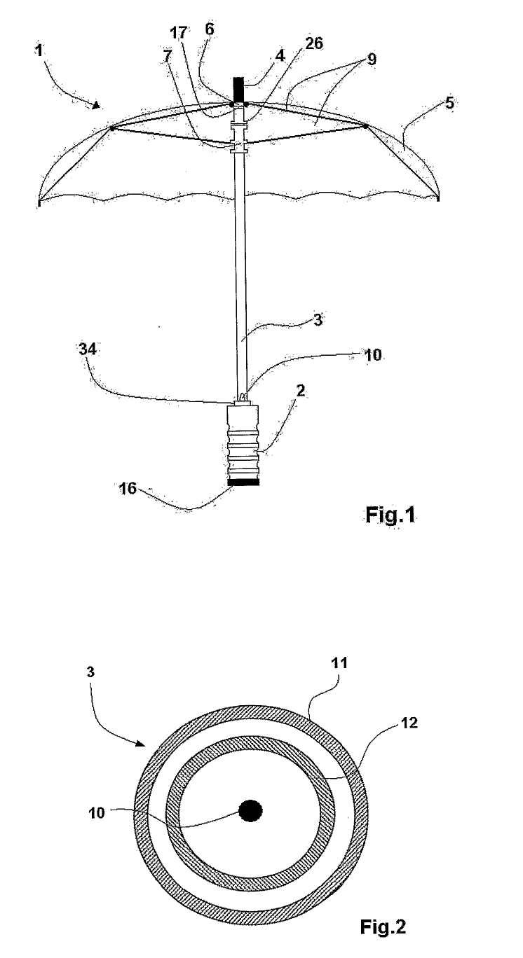

FIG. 1 is a side view of an umbrella according to the present invention;

FIG. 2 is a sectional view of the rod of the umbrella in FIG. 1;

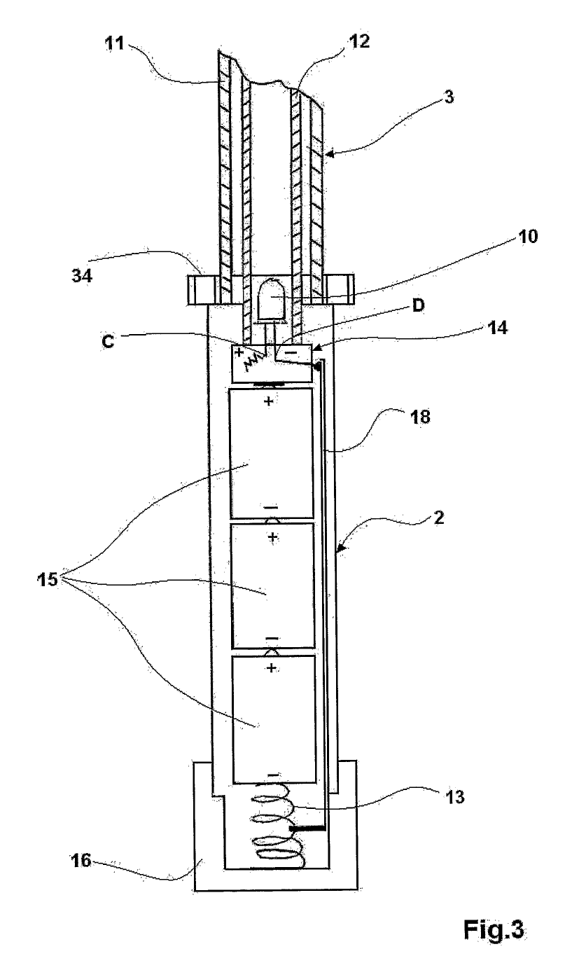

FIG. 3 is a sectional view of a detail of the umbrella according to the present invention;

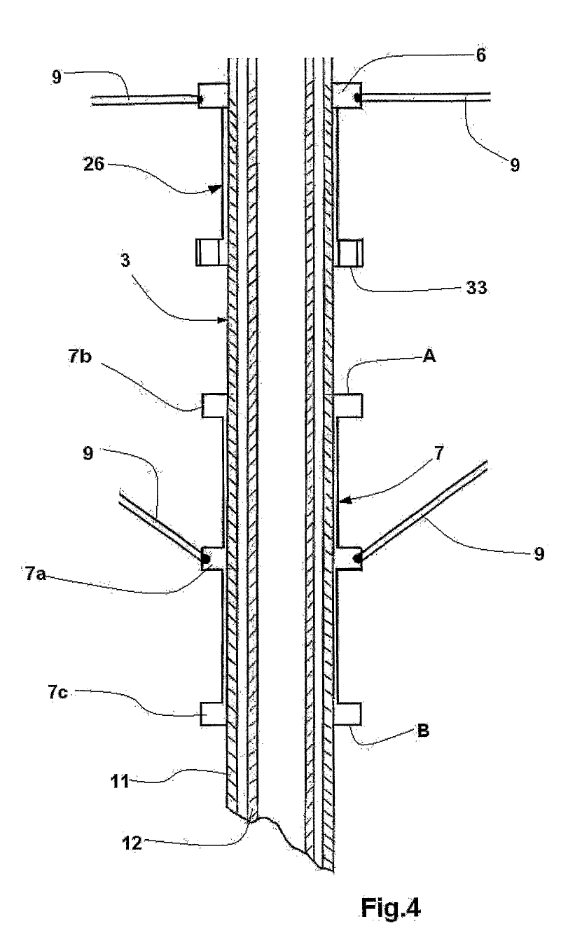

FIG. 4 is a sectional view of a rod of the umbrella shown in the previous figures;

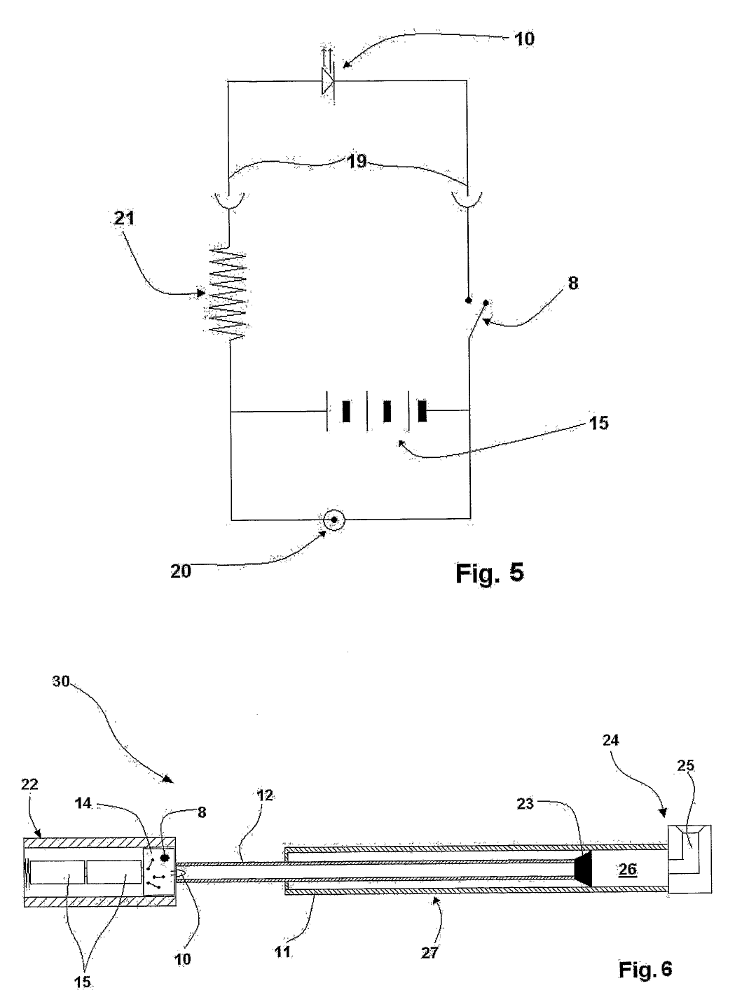

FIG. 5 shows schematically a feasible embodiment of an electric circuit for switching-on the lightening device according to the present invention;

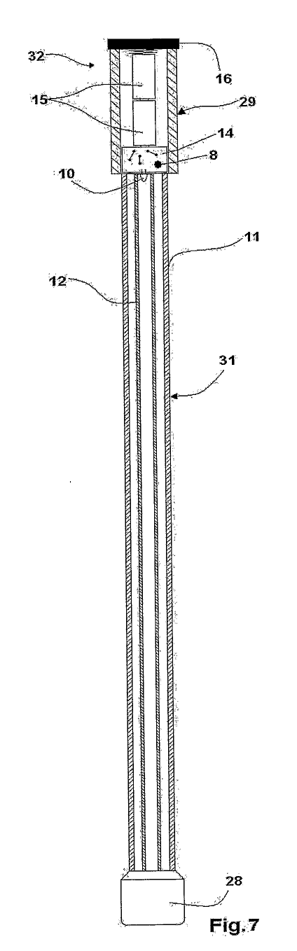

FIG. 6 shows a feasible embodiment of a lighted pump according to the present invention; and

FIG. 7 shows a feasible embodiment of a lighted stick according to the present invention.

Described herebelow with reference to the accompanying figures is a lighted umbrella 1 comprising substantially a handle 2, a rod 3 fixed on the handle 2, a structure 9 for bearing a sheltering cover 5 fixed to the rod 3, and a ferrule 4 disposed on the upper end of the rod 3 for fixing said sheltering cover 5, the latter being made, for example, of waterproof material.

The umbrella 1 further comprises a ring 6 capable of fixing the bearing structure 9 in proximity of the upper end of rod 3, and an abutment element 26 of a respective cursor 7 on which the structure 9 is hinged.

The ring 6 is solid to the upper end of rod 3.

The cursor 7 is able to slide on the rod 3 and has, advantageously, the bearing structure 9 hinged on the central part thereof.

Advantageously, the handle 2 comprises an electric circuit 14 connected to at least one LED 10 which faces the inside of the rod 3 to light it up by emitting a cold light.

The LED 10 having a diameter of 5 mm, for example, can emit white or coloured light with an absorption ranging from 10 to 20 mA.

Shown with reference in particular to FIGS. 2 to 4, is an embodiment of the umbrella 1 according to the present invention in which the rod 3 comprises at least a first 11 and a second 12 coaxial hoses of transparent material which can be fixed to the handle 2 by means of screw or bayonet-connecting elements, or by glueing.

The rod 3, in case it is fixed to the handle 2 by screw or bayonet-connecting elements, is rapidly separable from the same handle 2.

In this embodiment, the handle 2 is independent of the rest of the umbrella 1 and, advantageously, can be used as a normal torch.

Advantageously, the two hoses 11 and 12 are made of transparent plastics material, such as plexiglass or polycarbonate, the latter having optimal mechanical characteristics for resistance to shock and bending loads, and being therefore unbreakable to a high degree.

In particular, a preferred embodiment provides for an outer hose 11 made of polycarbonate.

The diameter of the outer hose 11 may be of 11-15 mm, while the one of the inner hose 12 is 6-10 mm, so as to dispose the led 10 midway inside the latter as shown in FIG. 2.

The hoses 11 and 12 may be mass-coloured directly upon the extrusion process by introducing, for example, fluorescent coloured pigments in the paste, or may be surface-painted, also with fluorescent pigments, through a spray process.

Both these colouring types allow achieving a wide range of chromatic effects with the light emitted by the rod 3.

More in particular, listed herebelow are some possible combinations between the coaxial hoses 11 and 12 and the LED 10.

a) Coloured inner hose 12 (mass-coloured or surface-painted) and transparent outer hose 11;

b) transparent inner hose 12 and coloured outer tube 11 (mass-coloured or surface-painted);

c) inner hose 12 and outer hose 11 both coloured (mass-coloured or surface-painted) also with different colours; and

d) inner hose 12 and outer hose 11 both transparent.

In each of the combinations listed above, it is possible to associate a LED 10 with white or coloured light. However, it should be appreciated that, in particular for the combination d), the whole obtainable chromatic effect of the umbrella 1 is limited to the colour of the light emitted by the LED 10 (for example, white, green, blue, red, orange, yellow).

Referring now in particular to FIGS. 3 and 4, an umbrella according to the invention advantageously comprises a closing/opening device of magnetic type.

Specifically, the closing device comprises a first magnet fixed on the upper end of the handle 2 and a second magnet 33 fixed on the lower abutment element 26, the latter being solid to the rod 3 in correspondence of the upper end.

In a preferred embodiment, the cursor 7, sliding along the rod 3 and preferably formed by molding, comprises three annular portions.

Hinged at the central portion 7a is the bearing structure 9, while the upper and lower portions 7b, 7c comprise a metal coated surface A, B, respectively.

In use, the two surfaces A, B come in contact with the magnets 34, 33 thereby determining the steady opening and closing positions of the umbrella 1.

The detachment of the cursor 7 from magnets 34, 33 is operated by the user acting with his/her fingers with no particular effort.

Obviously, the distance between the first and second magnets 34, 33 must be such as to allow a complete opening and closing of the umbrella 1.

In particular, the first magnet 34 is fixed to the upper end of handle 2, whereas the second magnet 33 is solid to the abutment element 26 which is fixed to the rod 3.

A preferred embodiment of an umbrella 1 according to the present invention further comprises a reflecting element 17 disposed inside the rod 3 to reflect the light emitted by the LED 10, at least in a certain direction, and to enhance, therefore, the luminosity of the rod 3 or of the internal surface of the sheltering cover 5 and bearing structure 9.

Advantageously, the reflecting element 17 comprises a mirror, or a painted surface providing a “mirror” effect, and is disposed inside the rod 3 in proximity of the internal surface of the sheltering cover 5 so as to reflect the light emitted by the led 10 inside the same rod 3.

The ferrule 4, disposed in the upper end of rod 3 can be made from a transparent material, likewise rod 3, or from an opaque material.

In case the ferrule 4 is made from transparent material, there is obtained, with the light emitted by LED 10, a pointing, torch-type effect which results visible even from a considerable distance.

The sheltering cover 5 is preferably made of waterproof material and may advantageously include fluorescent decorations or writing that are highlighted when hit by the light emitted by the LED 10.

FIG. 5 shows an exemplary electric circuit 14 for switching the led 10 on.

The electric circuit 14 may comprise an on/off switch 8, at least a battery 15 preferably rechargeable through a connector 20, a resistance 21 and two plugs 19 for a quick connection to at least one LED 10.

The batteries 15 may also, advantageously, be made of NiCd NiMh, LiPoly, Lilon, either rechargeable or of disposable type.

The circuit 14 is fed at low voltages (about 3-4 volts), while the absorbed power is about 10-20 mA; all this allowing a service life exceeding 80 hours without any appreciable reduction of luminosity.

The value of resistance 21 is preset to power the LED 10 with tolerable current under any operating condition (for example, for a LED with maximum absorption of 20 mA, the resistance must be 56 Ohm ¼ W).

The connector 20, in addition to act as an input for an external battery charger, may also serve for connecting the umbrella 1 with an external supplier, the latter to be connected, for example, to the network or a lighter socket. Shown in particular in FIG. 3 is a preferred embodiment of a handle 2 according to the present invention.

In this embodiment, the circuit 14 comprises a LED 10 having a positive pin connected with a resistance 21 (of 56 Ohm, for example), which is in turn connected with a contact surface C on which the positive pole of at least a battery 15 is made to rest.

The negative pin of LED 10 is instead connected with a second contact surface D, which is in turn connected with a conducting element 18.

The conducting element 18 runs lengthwise an internal channel of the handle 2, said channel serving as a container for the batteries 15.

In particular, the electric circuit 14 is closed by the contact of conducting element 18 on the negative pole of end battery 15.

The contact between the conducting element 18 and the negative pole of battery 15 is made via a spring 13 held within the cap 16 which closes the bottom part of handle 2. The spring 13, besides acting as a connecting element between the battery 15 and the conducting element 18, also provides for exerting the necessary pressure on the whole battery pack 15.

The cap 16 is connected on the lower end of handle 2, for example, by conventional thread means, so that, by screwing it, the circuit 14 is closed and the LED 10 is switched on.

By unscrewing only partially the cap 16, the circuit 14 is opened and the LED 10 is switched off.

Instead, by fully unscrewing the cap 16, the handle 2 is moved apart and the batteries 15 can be taken off.

A preferred embodiment of the cap 16 may comprise a cam system by which it is possible to perform three different functions: ON, OFF, and opening for the removal of the batteries 15.

Each of the above solution for the cap 16 allows a perfect impermeability of both the handle 2 and umbrella 1.

Although the above description relates to an umbrella 1, it will be appreciated that the same inventive idea can be extended to any other device requiring illumination and having suitable structural characteristics.

By way of example, some products that could be provided with a rod including two coaxial hoses of transparent material ed illuminated by at least one LED, comprise a pump for bicycles and a walking stick.

Shown in FIG. 5 is an embodiment of a pump 30 illuminated according to the present invention, in particular a pump for bicycles 30 provided with a rod 27.

The rod 27 comprises the outer hose 11 and the inner hose 12 coaxial to each other which carry out the function of cylinder and piston, respectively.

In particular, the outer hose 11 makes up the chamber within which the inner hose 12, fixed with one end to a handle 22 and with the other to a piston 23 preferably of elastic material, slides.

The sliding of piston 23 inside the hose 11 pushes the air toward an outlet valve 25 formed inside a head 24 fixed on the end of hose 11, distal of handle 22.

Preferably disposed inside the handle 22 is the electric circuit 14 for switching the led 10 on.

Similarly to the embodiment of the umbrella above described, the electric circuit 14 comprises an on/off switch 8, at least one battery 15, preferably of rechargeable type, and a quick connection to at least one LED 10.

The batteries 15 may also, advantageously, be made of NiCd NiMh, LiPoly, Lilon, either rechargeable or of disposable type.

For the pump too, the circuit 14 is fed at low voltages (about 3 volts), a factor which, being associated with the low consumption of energy of LED 10, allows a service life exceeding 80 hours without any appreciable reduction of luminosity.

With reference to FIG. 6, a possible embodiment of a lighted stick 32 comprises a rod 31, a handle 29 and an abutment element 28, the latter being preferably of elastic material and disposed at the end of rod 31, distal of handle 29.

As previously described in relation to both the umbrella 1 and pump 30, also in case of a stick 32 the rod 31 comprises an inner hose 12 and an outer hose 11 which are transparent and coaxial to each other; an electric circuit 14 being disposed within the handle 29 for switching-on the LED 10 which, advantageously, is made to face the inside of the stick 12.

The invention achieves major advantages.

A first advantage lies in the fact that the combination of the two hoses 11, 12 allows an optimal and uniform diffusion of the light emitted by the LED 10, so that the stick 3 is given a uniform “neon effect” lengthwise the same rod 3.

A second advantage lies in the fact that the use of types of hoses 11, 12, which are coloured by adding fluorescent pigments during the production process, makes it possible to obtain an almost infinite variety of colours and a luminosity enhanced by the fluorescence of the same pigments.

One no less important advantage is given by the fact that by using at least the outer tube 11 made of polycarbonate, there is obtained a device (for example, an umbrella 1, a pump 30, a stick 32) having high mechanical resistance to shock and bending loads.

This advantage is quite considerable inasmuch as the umbrella is an object of daily use and, during its use may be subjected to stresses of various kind and intensity.

A further advantage lies in the fact that by using a magnetic opening/closing system, as above described, there is obtained a high stability of the umbrella 1 both when open and closed.

Moreover, the use of a magnetic closing system allows eliminating slits that could endanger the integrity of rod as in the case of known system which provide, for example, for the insertion of spring system.

This advantage is important both because the light emitted is fully confined inside the rod and because the rod results tight-sealed.

The invention has been described in relation to a preferred embodiment thereof. However, it is understood that equivalent modifications can be made to the same invention without departing from the scope of the protection granted for the present industrial patent.

1. Lighted umbrella (1) comprising: a handle (2), a rod (3) fixed on said handle (2), a structure (9) for bearing a sheltering cover (5), said structure (9) being fixed to said rod (3), a ferrule (4) disposed on said rod (3) for fixing the waterproof sheltering cover (5), characterized in that said rod (3) comprises at least a first (11) and second (12) hoses of transparent material which are separated by a hollow space, and said handle (2) comprises an electric circuit (14) connected to at least one LED (10) facing the inside of said inner hose (12) to make said rod (3) luminous.

2. Umbrella according to claim 1 further comprising a closing device comprising at least a first (34) and a second (33) magnets.

3. Umbrella according to claim 1, comprising a reflecting element (17) disposed inside the rod (3) to reflect the light, emitted by said LED (10), at least in a given direction.

4. Umbrella according to claim 1, wherein said ferrule (4) is made of transparent material likewise said rod (3).

5. Umbrella according to claim 1, wherein said ferrule (4) is made of opaque material.

6. Umbrella according to claim 1, wherein said at least one of said hoses (11), (12) is made of polycarbonate.

7. Umbrella according to claim 1, wherein said at least one of said hoses (11), (12) is made of plexiglass.

8. Umbrella according to claim 1, wherein said at least one of said hoses (11), (12) comprises fluorescent coloured pigments.

9. Umbrella according to claim 1, wherein said sheltering cover (9) is made of fluorescent waterproof material.

10. Umbrella according to claim 1, wherein said LED (10) emits white light.

11. Umbrella according to claim 1, wherein said LED (10) emits coloured light.

12. Pump (30) comprising a handle (22), a rod (27) fixed on said handle (22), a head (24) comprising a valve (25) for the exit of air, characterized in that said rod (22) comprises at least a first (11) and a second (12) coaxial hoses made of transparent material and separated by hollow space, and in that said handle (22) comprises an electric circuit (14) connected to at least one LED (10), said LED (10) facing the inside of said hoses (11), (12) to light them up.

13. Stick (32) comprising a handle (29), a rod (31) fixed on said handle (29), an abutment element (28) fixed on said rod (31) distal of said handle (29), characterized in that said rod (31) comprises at least a first (11) and a second (12) coaxial hoses made of transparent material and separated by hollow space, and in that said handle (29) comprises an electric circuit (14) connected to at least one LED (10), said LED (10) facing the inside of said hoses (11), (12) to light them up.
